(19) United States
(12) Patent Application Publication
(10) Pub. No.: US 2019/0214907 A1
(43) Pub. Date: Jul. 11, 2019

(54) BOOST SYSTEM

(71) Applicant: TOYOTA JIDOSHA KABUSHIKI KAISHA, Toyota-shi (JP)

(72) Inventors: Toshifumi YAMAKAWA, Toyota-shi (JP); Ryo KAMIKAWA, Toyota-shi (JP); Kazuhito HAYASHI, Toyota-shi (JP); Kota OGURA, Toyota-shi (JP); Koji IRIE, Toyota-shi (JP)

(73) Assignee: TOYOTA JIDOSHA KABUSHIKI KAISHA, Toyota-shi (JP)

(21) Appl. No.: 16/243,182

(22) Filed: Jan. 9, 2019

(30) Foreign Application Priority Data
Jan. 11, 2018 (JP) 2018-002600

(51) Int. Cl. H02M 3/158; H02M 7/5387; H02P 27/06; H02M 1/08

(52) U.S. Cl. CPC H02M 3/158; H02M 7/53871; H02P 2201/09; H02M 1/08; H02P 27/06

(57) ABSTRACT

The boost system performs switching control of a first switching element and a second switching element, based on a result of comparison between the boost carrier and a duty command based on a required duty, with regard to each of a decreasing region where the boost carrier decreases and an increasing region where the boost carrier increases. The boost system sets the required duty to the duty command, with regard to the greater between the required duty in the decreasing region and the required duty in the increasing region, while setting the duty command by imposing a limitation on the required duty by lower limit guarding, such that an average duty in each one period of the boost carrier becomes equal to or greater than a lower limit duty, with regard to the smaller between the required duty in the decreasing region and the required duty in the increasing region.

### CROSS-REFERENCE TO RELATED APPLICATIONS

The present disclosure claims priority to Japanese Patent Application No. 2018-002600 filed Jan. 11, 2018, which is incorporated herein by reference in its entirety including specification, drawings and claims.

### TECHNICAL FIELD

The present disclosure relates to a boost system.

### BACKGROUND

In a boost system that is placed between a battery and an output capacitor and that is provided with a converter including first and second switching elements serving as an upper arm and a lower arm, first and second diodes, and a reactor, a proposed configuration controls an upper arm duty in each predetermined control period (as described in, for example, JP 2014-138486A). When each control period is divided into two sub-control periods or more specifically a first half sub-control period and a latter half sub-control period, this boost system does not impose a limitation with a lower limit value on the upper arm duty in one sub-control period out of the two sub-control periods of each control period, while imposing the limitation on the upper arm duty in the other sub-control period such as to be equal to or greater than the lower limit value of the upper arm duty in one control period.

### SUMMARY

When the upper arm duty of the other sub-control period out of the two sub-control periods of each control period is greater than the upper arm duty of one sub-control period, the configuration of the boost system described above increases a variation between the upper arm duty of one sub-control period and the upper arm duty of the other sub-control period.

A main object of a boost system of the present disclosure is to suppress an increase in variation of a duty in each one period of a boost carrier.

In order to achieve the above primary object, the boost system of the present disclosure employs the following configuration.

The present disclosure is directed to a boost system. The boost system includes a boost converter that includes first and second switching elements serving as an upper arm and a lower arm, first and second diodes, and a reactor and that is configured to transmit electric power between a first power line on a power source side and a second power line on an electric load side accompanied with voltage conversion and a control device configured to perform switching control of the first switching element and the second switching element, based on a result of comparison between a boost carrier and a duty command based on a required duty, with regard to each of a decreasing region where the boost carrier decreases and an increasing region where the boost carrier increases. The control device sets the required duty to the duty command with regard to the greater between the required duty in the decreasing region and the required duty in the increasing region, while setting the duty command by imposing a limitation on the required duty by lower limit guarding, such that an average duty in each one period of the boost carrier becomes equal to or greater than a lower limit duty, with regard to the smaller between the required duty in the decreasing region and the required duty in the increasing region.

The boost system according to this aspect of the present disclosure performs switching control of the first switching element and the second switching element, based on the result of comparison between the boost carrier and the duty command based on the required duty, with regard to each of the decreasing region where the boost carrier decreases and the increasing region where the boost carrier increases. The boost system sets the required duty to the duty command, with regard to the greater between the required duty in the decreasing region and the required duty in the increasing region, while setting the duty command by imposing a limitation on the required duty by lower limit guarding, such that the average duty in each one period of the boost carrier becomes equal to or greater than the lower limit duty, with regard to the smaller between the required duty in the decreasing region and the required duty in the increasing region. This configuration suppresses an increase in variation between the duty command in the decreasing region and the duty command in the increasing region in each one period of the boost carrier.

### BRIEF DESCRIPTION OF DRAWINGS

FIG. 1 is a configuration diagram illustrating the schematic configuration of an electric vehicle with a boost system mounted thereon according to one embodiment of the present disclosure;

FIG. 2 is a flowchart showing one example of a routine performed by the electronic control unit;

FIG. 3 is a diagram illustrating an example of changes in the required duty Dtag, the duty command D*, the boost carrier and the on-off state of the upper arm; and

FIG. 4 is a diagram illustrating another example of changes in the required duty Dtag, the duty command D*, the boost carrier and the on-off state of the upper arm.

### DESCRIPTION OF EMBODIMENTS

The following describes some aspects of the disclosure with reference to embodiments.

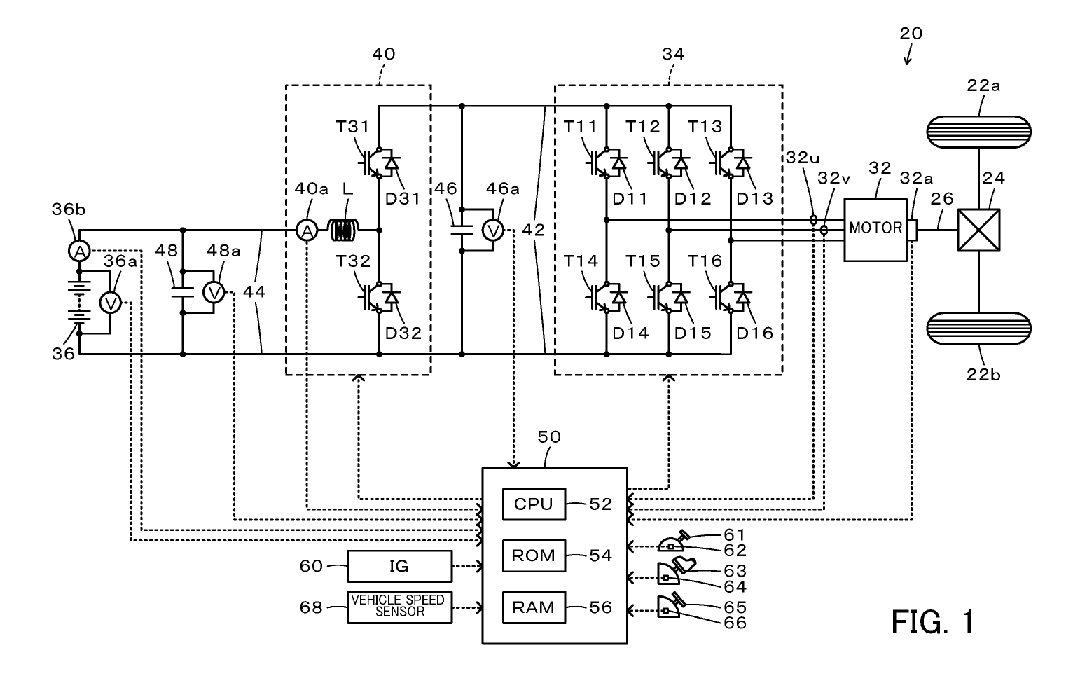

FIG. 1 is a configuration diagram illustrating the schematic configuration of an electric vehicle 20 with a boost system mounted thereon according to one embodiment of the present disclosure. As illustrated, the electric vehicle 20 of the embodiment includes a motor 32, an inverter 34, a battery 36 serving as a power source, a boost converter 40, and an electronic control unit 50. According to the embodiment, the boost converter 40 and the electronic control unit 50 are configured to serve as the “boost system”.

The motor 32 is configured as a synchronous generator motor and has a rotor with permanent magnets embedded therein and a stator with three-phase coils wound thereon. The rotor of this motor 32 is connected with a driveshaft 26 that is coupled with drive wheels 22a and 22b via a differential gear 24.

The inverter 34 is used to drive the motor 32. This inverter 34 is connected with the boost converter 40 via high voltage-side power lines 42 and includes six transistors T11 to T16 serving as switching elements and six diodes D11 to D16 that are respectively connected in parallel to the six transistors T11 to T16. The transistors T11 to T16 are arranged in pairs, such that two transistors in each pair respectively serve as a source and as a sink relative to a positive electrode line and a negative electrode line of the high voltage-side power lines 42. The respective phases of the three-phase coils (U phase, V phase and W phase) of the motor 32 are connected with connection points of the respective pairs of the transistors T11 to T16. Accordingly, when a voltage is applied to the inverter 34, the electronic control unit 50 regulates the rates of ON times of the respective pairs of the transistors T11 to T16 to provide a rotating magnetic field in the three-phase coils and thereby rotate and drive the motor 32. A capacitor 46 for smoothing is mounted to the positive electrode line and the negative electrode line of the high voltage-side power lines 42.

The battery 36 is configured by, for example, a lithium ion rechargeable battery or a nickel metal hydride battery and is connected with the boost converter 40 via low voltage-side power lines 44. A capacitor 48 for smoothing is mounted to a positive electrode line and a negative electrode line of the low voltage-side power lines 44.

The boost converter 40 is connected with the high voltage-side power lines 42 and with the low voltage-side power lines 44 and includes two transistors T31 and T32, two diodes D31 and D32 that are respectively connected in parallel to the two transistors T31 and T32, and a reactor L. The transistor T31 is connected with the positive electrode line of the high voltage-side power lines 42. The transistor T32 is connected with the transistor T31 and with the negative electrode lines of the high voltage-side power lines 42 and the low voltage-side power lines 44. The reactor L is connected with a connection point between the transistors T31 and T32 and with the positive electrode line of the low voltage-side power lines 44. The electronic control unit 50 regulates the rates of ON times of the respective transistors T31 and T32 and thereby causes the boost converter 40 to step up electric power of the low voltage-side power lines 44 and supply the stepped-up electric power to the high voltage-side power lines 42 and to step down electric power of the high voltage-side power lines 42 and supply the stepped-down electric power to the low voltage-side power lines 44. In the description below, the transistor T31 and the transistor T32 are also called “upper arm” and “lower arm”, respectively.

The electronic control unit 50 is configured as a CPU 52-based microprocessor and includes a ROM 54 configured to store processing programs, a RAM 56 configured to temporarily store data, and input/output ports, in addition to the CPU 52. Signals from various sensors are input into the electronic control unit 50 via the input port. The signals input into the electronic control unit 50 include, for example, a rotational position θm from a rotational position detection sensor (for example, a resolver) 32a configured to detect the rotational position of the rotor of the motor 32 and phase currents Iu and Iv from current sensors 32u and 32v configured to detect the phase currents of the respective phases of the motor 32. The input signals also include a voltage Vb from a voltage sensor 36a placed between terminals of the battery 36 and an electric current Ib from a current sensor 36b mounted to an output terminal of the battery 36. The input signals further include an electric current IL from a current sensor 40a mounted in series with the reactor L, a voltage VH of the capacitor 46 (high voltage-side power lines 42) from a voltage sensor 46a placed between terminals of the capacitor 46 and a voltage VL of the capacitor 48 (low voltage-side power lines 44) from a voltage sensor 48a placed between terminals of the capacitor 48. The input signals furthermore include an ignition signal from an ignition switch 60 and a shift position SP from a shift position sensor 62 configured to detect an operating position of a shift lever 61. The input signals further include an accelerator position Acc from an accelerator pedal position sensor 64 configured to detect a depression amount of an accelerator pedal 63, a brake pedal position BP from a brake pedal position sensor 66 configured to detect a depression amount of a brake pedal 65, and a vehicle speed V from a vehicle speed sensor 68.

Various controls signals are output from the electronic control unit 50 via the output port. The signals output from the electronic control unit 50 include, for example, switching control signals to the transistors T11 to T16 of the inverter 34 and switching control signals to the transistors T31 and T32 of the boost converter 40. The electronic control unit 50 calculates an electrician angle θe and a rotation speed Nm of the motor 32, based on the rotational position θm of the rotor of the motor 32 from the rotational position detection sensor 32a. The electronic control unit 50 also calculates a state of charge SOC of the battery 36, based on an integrated value of the electric current Ib of the battery 36 input from the current sensor 36b. The state of charge SOC denotes a ratio of an accumulated amount of electricity in the battery 36 (amount of dischargeable electric power) to the overall capacity of the battery 36.

In the electric vehicle 20 of the embodiment having the above configuration, the electronic control unit 50 sets a required torque Td* that is required for the driveshaft 26, based on the accelerator position Acc from the accelerator pedal position sensor 64 and the vehicle speed V from the vehicle speed sensor 68. The electronic control unit 50 sets the set required torque Td* to a torque command Tm* of the motor 32 and performs switching control of the transistors T11 to T16 of the inverter 34 such as to drive the motor 32 with the torque command Tm*. The electronic control unit 50 also sets a target voltage VH* of the high voltage-side power lines 42 to drive the motor 32 with the torque command Tm*, sets a target current IL* of the reactor L to cancel out a difference between the voltage VH of the high voltage-side power lines 42 (capacitor 46) from the voltage sensor 46a and the target voltage VH*, and sets a required duty Dtag to cancel out a difference between the electric current IL of the reactor L from the current sensor 40a and the target current IL*. The electronic control unit 50 sets a duty command D* based on the set required duty Dtag, provides a dead time based on a result of comparison between the duty command D* and a boost carrier, and performs switching control of the transistors T31 and T32 of the boost converter 40.

The required duty Dtag and the duty command D* respectively denote a required value and a command value with regard to a ratio of the ON time to the sum of the ON time and the OFF time of the upper arm (transistor T31) (ratio of the OFF time to the sum of the ON time and the OFF time of the lower arm (transistor T32)) without taking into account the dead time.

According to the embodiment, a required duty Dtag in a decreasing region (hereinafter may be expressed as “Dtagdn”) where the boost carrier is expected to decrease from a crest (maximum value) to a trough (minimum value) next time is set in arithmetic processing (interrupt processing) from the timing of the trough of the boost carrier. A required duty Dtag in an increasing region (hereinafter may be expressed as “Dtagup”) where the boost carrier is expected to increase from a trough to a crest next time is set in arithmetic processing from the timing of the crest of the boost carrier.

According to the embodiment, with regard to one of the required duty Dtag (Dtagdn) in the decreasing region and the required duty Dtag (Dtagup) in the increasing region, the duty command D* is set equal to the required duty Dtag. With regard to the other of required duties Dtag, on the other hand, the duty command D* is set by imposing a limitation on the required duty Dtag by lower limit guarding, such that an average duty Dave (=(Dtagup+Dtagdn)/2) in each period of the boost carrier is equal to or greater than a lower limit duty Dmin. The smaller average duty Dave provides the longer ON time and the shorter OFF time of the transistor T32. This is likely to increase an amount of change (amount of increase) in the electric current IL of the reactor L per unit time, is likely to provide the excessive electric current IL of the reactor L and the excessive electric current Ib of the battery 36, and is likely to cause a failure in sufficiently taking out the electric power from the battery 36 due to a voltage drop by the internal resistance of the battery 36. The lower limit duty Dmin is provided to suppress the occurrence of such troubles. The lower limit duty Dmin used may be, for example, 35%, 40% or 45%.

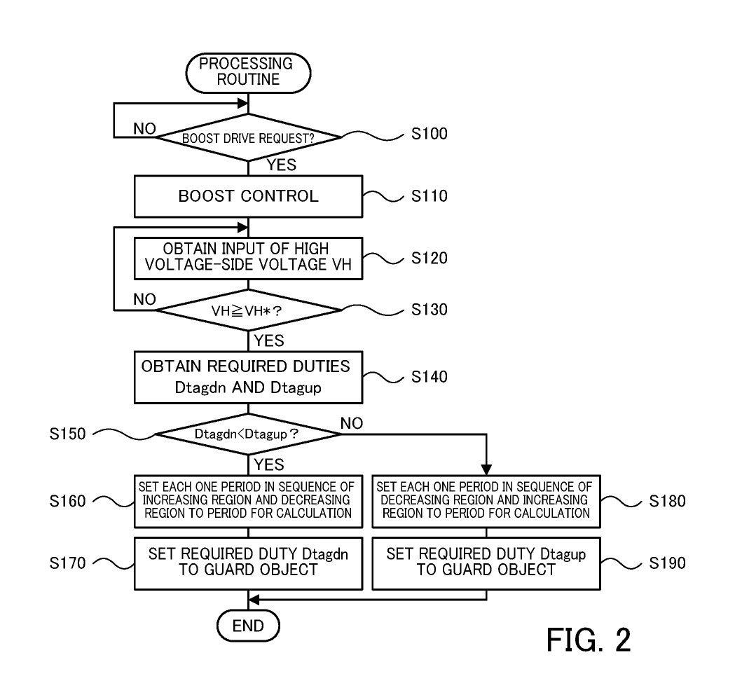

The following describes the operations of the electric vehicle 20 of the embodiment having the configuration described above or more specifically a series of processing to determine whether each one period in the sequence of the decreasing region and the increasing region or each one period in the sequence of the increasing region and the decreasing region is set to a period for calculation that is each one period of the boost carrier for calculation of the average duty Dave and a series of processing to determine whether the required duty Dtagdn in the decreasing region or the required duty Dtagup in the increasing region is set to a guard object that is an object that is subject to lower limit guarding. FIG. 2 is a flowchart showing one example of a routine performed by the electronic control unit 50. This processing routine is performed at a start of the system (when the ignition switch 60 is switched on).

When the processing routine of FIG. 2 is triggered, the electronic control unit 50 determines whether a drive request for the boost converter 40 is given (step S100). When no drive request for the boost converter 40 is given, the electronic control unit 50 waits until a drive request for the boost converter 40 is given. The determination of whether a drive request for the boost converter 40 is given may be based on checking whether the target voltage VH* of the high voltage-side power lines 42 becomes higher than the voltage VL of the low voltage-side power lines 44.

When it is determined at step S100 that a drive request for the boost converter 40 is given, the electronic control unit 50 performs switching control of the transistors T31 and T32 of the boost converter 40, such that the voltage VH of the high voltage-side power lines 42 approaches the target voltage VH* (step S110). The electronic control unit 50 subsequently obtains the voltage VH of the high voltage-side power lines 42 (capacitor 46) input from the voltage sensor 46a (step S120) and compares the input voltage VH of the high voltage-side power lines 42 with the target voltage VH* (step S130). When the voltage VH of the high voltage-side power lines 42 is lower than the target voltage VH* the electronic control unit 50 returns the processing flow to step S120. In this manner, the electronic control unit 50 waits until the voltage VH of the high voltage-side power lines 42 becomes equal to or higher than the target voltage VH*.

When the voltage VH of the high voltage-side power lines 42 becomes equal to or higher than the target voltage VH*, the electronic control unit 50 obtains the required duty Dtagdn in the decreasing region and the required duty Dtagup in the increasing region (step S140) and compares the two obtained required duties Dtagdn and Dtagup with each other (step S150).

When the required duty Dtagdn in the decreasing region is smaller than the required duty Dtagup in the increasing region at step S150, the electronic control unit 50 sets each one period in the sequence of the increasing region and the decreasing region to the period for calculation (step S160), sets the required duty Dtagdn in the decreasing region to the guard object (step S170) and then terminates this routine.

When the required duty Dtagup in the increasing region is equal to or smaller than the required duty Dtagdn in the decreasing region at step S150, on the other hand, the electronic control unit 50 sets each one period in the sequence of the decreasing region and the increasing region to the period for calculation (step S180), sets the required duty Dtagup in the increasing region to the guard object (step S190) and then terminates this routine.

After setting the period for calculation and the guard object by the processing routine of FIG. 2, the electronic control unit 50 subsequently sets the duty command D*, based on the required duty Dtag by taking into account the set period for calculation and the set guard object, and controls the transistors T31 and T32 of the boost converter 40 by using this duty command D*. The magnitude relationship between the required duty Dtagup in the increasing region and the required duty Dtagdn in the decreasing region is based on a dead time and a control delay in the actual switching operations of the transistors T31 and T32 and detection delays of the current sensor 40a and the voltage sensor 46a and is basically not changed in one trip once being determined.

As described above, with regard to the smaller between the required duty Dtag in the decreasing region (Dtagdn) and the required duty Dtag in the increasing region (Dtagup), the duty command D* is set by imposing a limitation on the required duty Dtag by lower limit guarding, such that the average duty Dave in the period for calculation becomes equal to or greater than the lower limit duty Dmin. This configuration suppresses an increase in variation between the required duty Dtag in the decreasing region (Dtagdn) and the required duty Dtag in the increasing region (Dtagup).

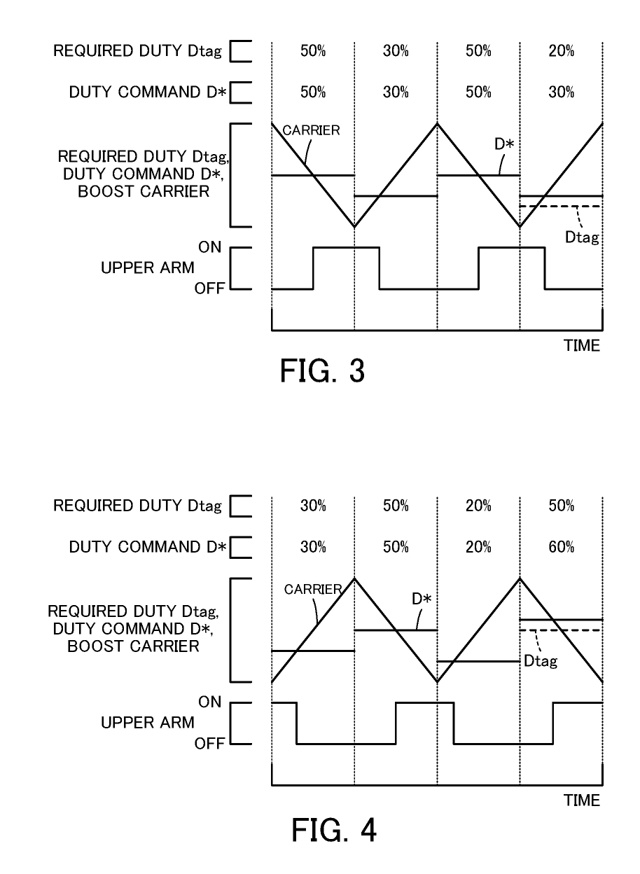

FIG. 3 and FIG. 4 are diagrams illustrating examples of changes in the required duty Dtag, the duty command D*, the boost carrier and the on-off state of the upper arm. FIG. 3 shows the changes according to the embodiment, and FIG. 4 shows the changes according to a comparative example. According to the comparative example, as shown in FIG. 4, a limitation by lower limit guarding is imposed on the greater between the required duty Dtagdn in the decreasing region and the required duty Dtagup in the increasing region. This increases the variation of the duty command D*. According to the embodiment, on the other hand, as shown in FIG. 3, a limitation by lower limit guarding is imposed on the smaller between the required duty Dtagdn in the decreasing region and the required duty Dtagup in the increasing region. This suppresses an increase in variation of the duty command D*.

As described above, the boost system mounted on the electric vehicle 20 according to the embodiment sets the required duty Dtag to the duty command D* with regard to the greater between the required duty Dtag in the decreasing region (Dtagdn) and the required duty Dtag in the increasing region (Dtagup), while setting the duty command D* by imposing a limitation on the required duty Dtag by lower limit guarding, such that the average duty Dave in the period for calculation becomes equal to or greater than the lower limit duty Dmin, with regard to the smaller between the required duties Dtagdn and Dtagup. This configuration suppresses an increase in variation between the required duty Dtag in the decreasing region (Dtagdn) and the required duty Dtag in the increasing region (Dtagup).

The boost system mounted on the electric vehicle 20 according to the embodiment obtains and compares the required duty Dtagdn in the decreasing region and the required duty Dtagup in the increasing region when the voltage VH of the high voltage-side power lines 42 is stepped up for the first time by driving the boost converter 40 after a system start. According to a modification, however, the magnitude relationship between the required duty Dtagup in the increasing region and the required duty Dtagdn in the decreasing region may be unequivocally determined in advance, based on the dead time and the control delay in the actual switching operations of the transistors T31 and T32 and the detection delays of the current sensor 40a and the voltage sensor 46a.

The electric vehicle 20 of the embodiment uses the battery 36 as the power source. A capacitor may be used as the power source, in place of the battery 36.

The embodiment describes the aspect of the boost system mounted on the electric vehicle 20 that is equipped with the motor 32. The present disclosure may also be implemented by an aspect of the boost system mounted on a hybrid vehicle that is equipped with an engine in addition to the motor 32. The present disclosure may further be implemented by an aspect of the boost system mounted on a moving body such as a vehicle other than the motor vehicle, a ship or board or an airplane or may be implemented by an aspect of the boost converter mounted on stationary equipment such as construction equipment.

In the boost system of this aspect, the control device may set the each one period to a sequence of the greater between the required duty in the decreasing region and the required duty in the increasing region and the smaller between the required duty in the decreasing region and the required duty in the increasing region. This configuration imposes a limitation by lower limit guarding on the required duty of the latter half period in each one period and thereby causes the average duty in each one period to be equal to or greater than the lower limit duty.

In the boost system of another aspect, the control device may include the required duty in the decreasing region with the required duty in the increasing region, when a voltage of the second power line is stepped up first by driving the boost converter after a system start. This configuration determines whether a limitation by lower limit guarding is to be imposed on the required duty in the decreasing region or on the required duty in the increasing region, when the voltage of the second power line is stepped up for the first time.

The following describes the correspondence relationship between the primary components of the embodiment and the primary components of the disclosure described in Summary. The boost converter 40 of the embodiment corresponds to the “boost converter”, the electronic control unit 50 corresponds to the “control device”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is preferably applicable to the manufacturing industries of the boost system and so on.

1. A boost system, comprising:
a boost converter that includes first and second switching elements serving as an upper arm and a lower arm, first and second diodes, and a reactor and that is configured to transmit electric power between a first power line on a power source side and a second power line on an electric load side accompanied with voltage conversion; and
a control device configured to perform switching control of the first switching element and the second switching element, based on a result of comparison between a boost carrier and a duty command based on a required duty, with regard to each of a decreasing region where the boost carrier decreases and an increasing region where the boost carrier increases, wherein
the control device sets the required duty to the duty command with regard to the greater between the required duty in the decreasing region and the required duty in the increasing region, while setting the duty command by imposing a limitation on the required duty by lower limit guarding, such that an average duty in each one period of the boost carrier becomes equal to or greater than a lower limit duty, with regard to the smaller between the required duty in the decreasing region and the required duty in the increasing region.

2. The boost system according to claim 1,
wherein the control device sets the each one period to a sequence of the greater between the required duty in the decreasing region and the required duty in the increasing region and the smaller between the required duty in the decreasing region and the required duty in the increasing region.

3. The boost system according to claim 1,
wherein the control device compares the required duty in the decreasing region with the required duty in the increasing region, when a voltage of the second power line is stepped up first by driving the boost converter after a system start.

4. The boost system according to claim 2,
wherein the control device compares the required duty in the decreasing region with the required duty in the increasing region, when a voltage of the second power line is stepped up first by driving the boost converter after a system start.
